(19) United States
(12) Patent Application Publication
(10) Pub. No.: US 2005/0195425 A1
(43) Pub. Date: Sep. 8, 2005

(54) Email confirmation for specified task at print device

(76) Inventors: Amanda K. Bridges, Winchester, KY (US); William J.G. Flowers, Lexington, KY (US); Charles E. Grieshaber, Versailles, KY (US); Michael R. Timperman, Versailles, KY (US); Milamaria S. Turbek, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/764,163

(22) Filed: Jan. 24, 2004

(51) Int. Cl. G06F 15/00

(52) U.S. Cl. 358/1.15; 709/206

(57) ABSTRACT

A method of using a print device, includes the steps of: carrying out a specified task at a print device; and generating an email confirmation including an indication of success or failure of the carried out task at the print device.

### BACKGROUND OF THE INVENTION

1. Field of the Invention

The present invention relates to printers and multifunction devices, and, more particularly, to a method of using such devices attached to a network.

2. Description of the Related Art

Client computers are commonly connected with each other and with a server over a network. A client computer may be directly connected to a peripheral device, such as a multi-function machine, which includes printer, scanner, facsimile and copier functions. Alternatively, the peripheral device may be coupled to the network for communication with one or more of the client machines.

The scanner and fax components or units of the multi-function machine may both be used as input devices for the creation of an image data file containing image data which is to be transmitted over the network to a client computer. In the case of a network connected machine, a user may place a page to be scanned on the multi-function machine and provide instructions that the image data file be transmitted as an e-mail attachment to the user's client machine located at a different part of the building. As a further example, the scan to network job may be transmitted as an email to a different user attached to the network. If the scan to network job is transmitted to a different user, the person sending the scanned image data file may need to verify with the third party that the image was scanned successfully and transmitted successfully over the network. If the user is informed by the third party that the scan to network job was not successfully received by the third party, then the user must then return to the peripheral device, rescan the page and retransmit the e-mail over the network. This can be frustrating and can result in lost productivity for the user.

Similarly, a multi-function machine may be used to receive fax data which is transmitted over a network to a client computer or to send fax data received from a client computer attached to the network. It again would be desirable to have an automatic way of verifying that the fax data is sent or received successfully.

What is needed in the art is a method of verifying to a user that a specified task at a print device is successfully or unsuccessfully carried out.

### SUMMARY OF THE INVENTION

The present invention provides an email confirmation indicating success or failure of a specified task carried out at a print device, and including a thumbnail image upon successfully carrying out the specified task.

The invention comprises, in one form thereof, a method of using a print device, including the steps of: carrying out a specified task at a print device; and generating an email confirmation including an indication of success or failure of the carried out task at the print device.

An advantage of the present invention is that a user is provided with an email confirmation indicating success or failure of a specified task to be carried out at a print device.

Another advantage is that a thumbnail image of rendered image data associated with the specified task may also be provided to the user.

Yet another advantage is that additional information pertaining to an attached rendered image data file is also provided to the user, such as file name, data format, resolution, etc.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of an embodiment of a computer system which may be used with the method of using a printer of the present invention;

FIG. 2 is a flow chart of an embodiment of the method of using a printer of the present invention; and

FIG. 3 is a schematic illustration of another embodiment of a computer system which may be used with the method of using a printer of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

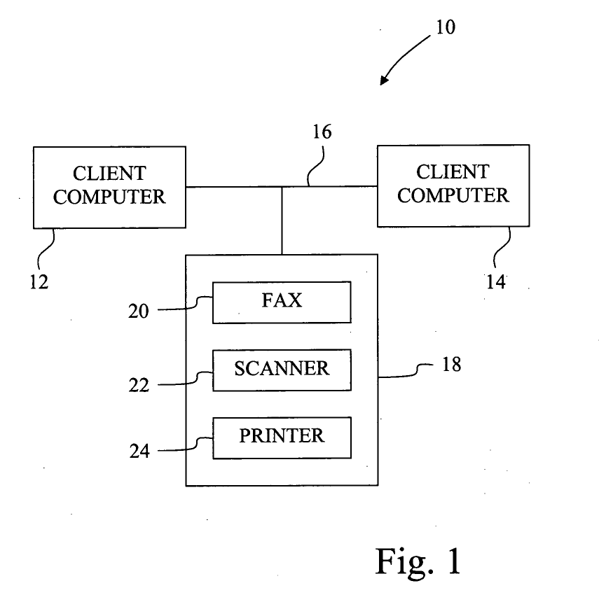

Referring now to the drawings, and particularly to FIG. 1, there is shown an embodiment of computer system 10, which may be used for carrying out an embodiment of a method of using a printer of the present invention. Computer system 10 generally includes a client computer 12 which communicates with another client computer 14 via a network 16. Computer system 10 may also include a number of additional client computers or a server (not shown) which are likewise connected with network 16.

Client computers 12 and 14 are also coupled with a multifunction machine (MFM) 18. MFM 18 has multiple functional components, including fax or fax component 20, scanner or scanner component 22 and printer or printing component 24. Printer 24 provides MFM 18 with printing capabilities; and thus MFM 18 can broadly be termed a “print device” or “printing apparatus.” Printer 24 may be any suitable type of printing component, such as an ink jet printer, laser printer, etc. Moreover, printer 24 need not be coupled with network 16, but may be connected to a client computer 12 or 14.

MFM 18 is a smart machine which may have internal logic and/or software (not shown) which allows MFM 18 to transmit an e-mail over network 16 to client computer 12 and/or 14. For example, multifunction machine 18 can transmit an e-mail indicating success or failure of a scan to network job utilizing scanner component 22. As a further example, multifunction machine 18 can transmit an e-mail over network 16 indicating success or failure of a transmitted or received fax using fax component 20. As a still further example, multifunction machine 18 can transmit an e-mail over network 16 indicating success or failure of a printed image data file using printer or printing component 24.

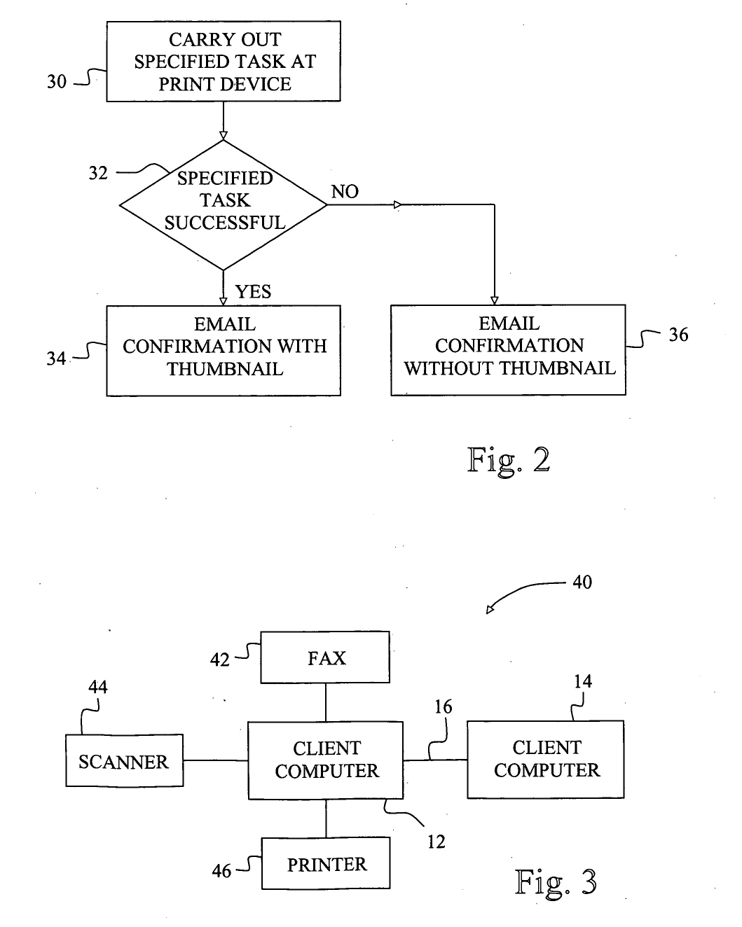

Upon completion of a specified task as described above (FIG. 2; block 30), e.g., a determination is made as to whether the specified task at MFM 18 was carried out successfully (decision block 32). Regardless of whether the specified task was carried out successfully or unsuccessfully, MFM 18 automatically generates and transmits an email confirmation to one or more client computers 12 and/or 14.

Upon a successful transmission of a scan to network job, an e-mail confirmation in the form of a confirmation report is automatically generated. This e-mail confirmation may then be transmitted to the email address associated with the login user, to the default administrator email address or to some other email address designated by the user. The email confirmation for a scan to network job may include the following information upon successful transmission:
Job success
Date
To (scan destination)
From (scan origination)
Subject
Message
File attachment(s) information, including but not limited to file name, image format (JPEG, TIFF, etc.), and scan resolution
One or more thumbnail images of the scanned page(s) (e.g., one thumbnail per scanned page) that is sent with the e-mail as an attached file

Additional information may also be included on the email confirmation if the user so desires.

Upon an unsuccessful transmission of a scan to network job, an e-mail confirmation is likewise automatically generated. This e-mail confirmation may then be transmitted to the email address associated with the login user, or to the default administrator email address, or to some other email address designated by the user. The email confirmation may include the following information upon unsuccessful transmission:
Primary SMTP Gateway IP address
Connection failure, number of tries
Mail server response

Upon a successful transmission of a fax job, an e-mail confirmation is automatically generated. The e-mail confirmation may then be transmitted to the email address associated with the login user, to the default administrator email address or to some other email address designated by the user. The email confirmation may include the following information for a fax job upon successful transmission:
Job success
Date
Station name
Station number
Pages sent
Duration of call
Time sent
One or more thumbnail images of the scanned page(s) (e.g., a single thumbnail of the first fax page) that is sent with the e-mail as an attached file

Additional information may also be included on the email confirmation if the user so desires.

Upon an unsuccessful transmission of a fax job, an e-mail confirmation is likewise automatically generated. The email confirmation may then be transmitted to the email address associated with the login user, to the default administrator email address or to some other email address designated by the user. The email confirmation includes the following information upon unsuccessful transmission:
Connection failure, number of tries
Date
Station name
Station number

The e-mail confirmation may or may not include a thumbnail image if the specified task is not successfully carried out at MFM 18 (e.g., an unsuccessful scan to network job or fax job). Regardless of whether the specified task was successful or unsuccessful, the user is automatically provided with an email confirmation, with the format of the email confirmation being dependent upon the success or failure of the specified task.

It is also possible that the email confirmation can be generated within MFM 18 without automatically transmitting the email confirmation over the network to the user. Configured in this manner, the user is likely prompted to determine whether the email confirmation is to be transmitted, or whether a simple indication of success or failure of the specified task is to be displayed on a display screen, etc.

FIG. 3 illustrates another embodiment of a computer system 40, which may be used for carrying out an embodiment of a method of using a printer of the present invention. Computer system 40 includes client computers 12 and 14 coupled with a network 16, similar to the embodiment of computer system 10 shown in FIG. 1.

Client computer 12 is also coupled with a fax 42, scanner 44 and printer 46. Fax 42, scanner 44 and printer 46 are shown as separate device blocks in FIG. 3. However, the functionality of these peripheral devices is the same as fax 20, scanner 22 and printer 24 regardless shown as integrated into one device in FIG. 1. Therefore, fax 42, scanner 44 and printer 46 shown in FIG. 3 will not be described in further detail.

Client computer 12 shown in FIG. 3 may also include appropriate software for transmitting an email confirmation over network 16 to client computer 14. The email confirmation corresponds to a specified task carried out at fax 42, scanner 44 or printer 46 shown in FIG. 3. Upon successfully carrying out the specified task, the email confirmation can include a thumbnail image of input image data received at the peripheral component attached to client computer 12.

It will be appreciated by those skilled in the art that the structural configurations of the various components attached to the network may vary from one application to another. Moreover, the methodology and logic of the present invention described herein may be carried out using any number of configurations such as electronic hardware, software, and/or firmware, or the like.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of using a print device, comprising the steps of:
carrying out a specified task at a print device; and
generating an email confirmation including an indication of success or failure of said carried out task at said print device.

2. The method of claim 1, wherein said step of carrying out a specified task includes rendering image data at said print device.

3. The method of claim 2, wherein said rendered image data corresponds to one of a scan to network job and a fax job.

4. The method of claim 1, wherein said email confirmation relates to a scan to network job.

5. The method of claim 4, wherein said email confirmation includes upon said failure at least one of a primary SMTP gateway IP address; a connection failure, and number of connection tries; and a mail server response.

6. The method of claim 1, wherein said email confirmation relates to a fax job.

7. The method of claim 6, wherein said email confirmation includes upon said failure at least one of a connection failure, and number of connection tries; date; station name; and station number.

8. The method of claim 2, wherein said email confirmation includes a thumbnail image associated with said rendered image data upon a successful rendering of said image data, and said email confirmation does not include a thumbnail image associated with said rendered image data upon an unsuccessful rendering of said image data.

9. The method of claim 2, wherein said email confirmation includes an attachment.

10. The method of claim 9, wherein said email confirmation includes a thumbnail image of said attachment.

11. The method of claim 9, wherein said email confirmation includes a thumbnail image of said attachment upon a successful rendering of said image data, and said email confirmation does not include a thumbnail image of said attachment upon an unsuccessful rendering of said image data.

12. The method of claim 9, wherein said email confirmation comprises information relating to said attachment, including at least one of a file name, data format, and rendered image resolution.

13. The method of claim 1, wherein said generating step includes the substep of transmitting said email confirmation over a network.

14. The method of claim 13, wherein said transmitting step includes transmitting said email confirmation over a network using one of said print device and a computer attached to said network.

15. The method of claim, 1 wherein said print device is part of a multi-function machine.

16. A method of using a print device, comprising the steps of:
carrying out a specified task at a print device; and
generating an email confirmation including an indication of success or failure of said carried out task at said print device, said email confirmation including a thumbnail image associated with said specified task upon successfully carrying out said specified task, and said email confirmation not including a thumbnail image associated with said specified task upon unsuccessfully carrying out said specified task.

17. The method of claim 16, wherein said step of carrying out a specified task includes rendering image data at said print device.

18. The method of claim 17, wherein said rendered image data corresponds to one of a scan to network job and a fax job.

19. The method of claim 17, wherein said email confirmation includes a thumbnail image associated with said rendered image data upon a successful rendering of said image data, and said email confirmation does not include a thumbnail image associated with said rendered image data upon an unsuccessful rendering of said image data.

20. The method of claim 16, wherein said email confirmation includes an attachment.

21. The method of claim 16, wherein said generating step includes the substep of transmitting said email confirmation over a network.

22. The method of claim 21, wherein said transmitting step includes transmitting said email confirmation over a network using one of said print device and a computer attached to said network.

23. The method of claim, 16 wherein said print device is part of a multi-function machine.

24. A method of using a print device, comprising the steps of:
carrying out a specified task at a print device; and
generating an email confirmation at said print device, said email confirmation including information pertaining to said specified task.

25. The method of claim 24, wherein said email confirmation includes an indication of success or failure of said specified task.

26. The method of claim 24, wherein said step of carrying out a specified task includes rendering image data at said print device.

27. The method of claim 26, wherein said rendered image data corresponds to one of a scan to network job and a fax job.

28. The method of claim 24, wherein said email confirmation includes a thumbnail image associated with said rendered image data.

29. The method of claim 24, wherein said automatically generating step includes the substep of transmitting said email confirmation over a network.

30. The method of claim 29, wherein said transmitting step includes transmitting said email confirmation over a network using one of said print device and a computer attached to said network.

31. The method of claim, 24 wherein said print device is part of a multi-function machine.

32. A method of using a print device, comprising the steps of:
coupling a print device and a computer to a network at different physical locations;
carrying out a specified task at one of said print device and said computer;
generating a confirmation report indicating success or failure of said specified task; and
providing access to said confirmation report at an other of said print device and said computer.

33. The method of claim 32, wherein said print device comprises a multifunction machine including a fax, scanner and printer; said specified task comprises one of a scan to network job using said scanner and fax job using said fax; and said confirmation report comprises an email confirmation.
